(19) United States
(12) Patent Application Publication
(10) Pub. No.: US 2003/0086408 A1
(43) Pub. Date: May 8, 2003

(54) Television receiver arrangement and method of effecting a channel switch in a television receiver

(76) Inventor: Mayank Goel, Bangalore (IN)

Correspondence Address: U.S. Philips Corporation, 580 White Plains Road, Tarrytown, NY, 10591, US

(21) Appl. No.: 10/274,399

(22) Filed: Oct. 18, 2002

(30) Foreign Application Priority Data
Oct. 23, 2001 (EP) 01204024.2

(51) Int. Cl. H04J 3/24

(52) U.S. Cl. 370/349

(57) ABSTRACT

A television receiver arrangement comprises means for receiving a television signal comprising a plurality of channels and a tuner for tuning in to one of the channels, and capable of receiving data broadcast transmissions. It further comprises a data processor for decoding the data (30), which data processor is adapted to directing the tuner to switch to a channel specified in a resource indicator (16, 17) comprised in the data (30). The data processor is programmed to trigger a channel switch upon receipt and identification of a specific trigger identifier (15) comprised in the data (30).

In a method of effecting a channel switch in a television receiver (4, 6-8) capable of receiving and tuning in to one of a plurality of channels provided in a television signal, data broadcast transmissions are received and decoded, a resource indicator (16, 17) specifying a channel is extracted from the data (30) received, and the television receiver (4, 6-8) is instructed to switch to the specified channel. The channel switch is triggered by receipt and identification of a specific trigger identifier (15) in a message comprised in the data (30).

The invention relates to a television receiver arrangement, comprising means for receiving a television signal comprising a plurality of channels and a tuner for tuning in to one of the channels, and capable of receiving data broadcast transmissions, the arrangement further comprising a data processor for decoding the data, which data processor is adapted to directing the tuner to switch to a channel specified in a resource indicator comprised in the data

The invention further relates to a method of effecting a channel switch in a television receiver capable of receiving and tuning in to one of a plurality of channels provided in a television signal, wherein data broadcast transmissions are received and decoded, a resource indicator specifying a channel is extracted from the data received, and the television receiver is instructed to switch to the specified channel.

DE 44 38 412 discloses a system for switching channels on a television using a teletext decoder. The user is presented with a teletext page providing an overview of different available channels and the programs currently being broadcast on these channels. Upon selection of one of these channels using a cursor controlled by the user, a switch to the selected channel is effected.

The disclosed system relies on the user first selecting the overview page. It is not possible to bring a program on a different channel from the one he is watching to his attention.

It is an object of the invention to provide a television receiver arrangement and method of the above-described kind that provides a better way of bringing a channel to which the user might like to switch to his attention.

Accordingly, the television receiver arrangement according to the invention is characterised in that the data processor is programmed to trigger a channel switch upon receipt and identification of a specific trigger identifier comprised in the data.

The method according to the invention is characterised in that the channel switch is triggered by receipt and identification of a specific trigger identifier in a message comprised in the data.

Thus, by inserting the trigger identifier in the data, a user can be alerted to the channel to which he might like to switch, without him taking the initiative.

In a preferred embodiment of the method according to the invention, wherein the trigger message comprises an attribute, prompting the user to confirm the channel switch, the channel switch is completed upon the user's confirmation. Thus, although the channel switch is triggered automatically and externally, the user retains control over channel selection.

The invention will now be explained in further detail with reference to the enclosed drawings, of which

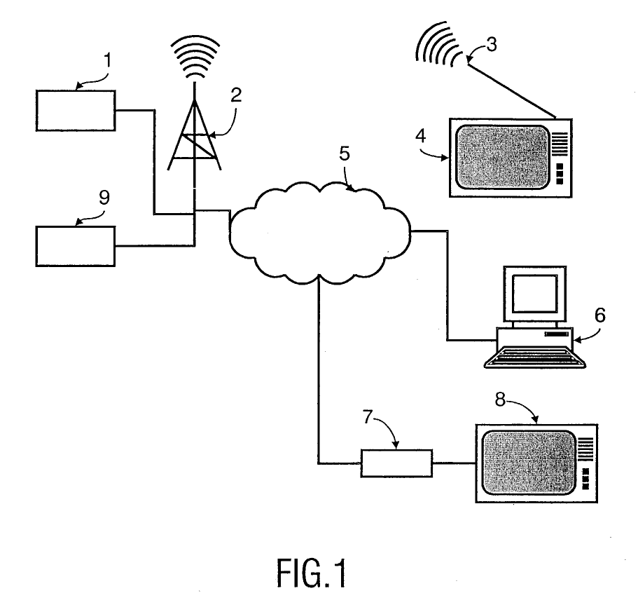

FIG. 1 shows very schematically the composition of a television broadcast system according to an embodiment of the invention,

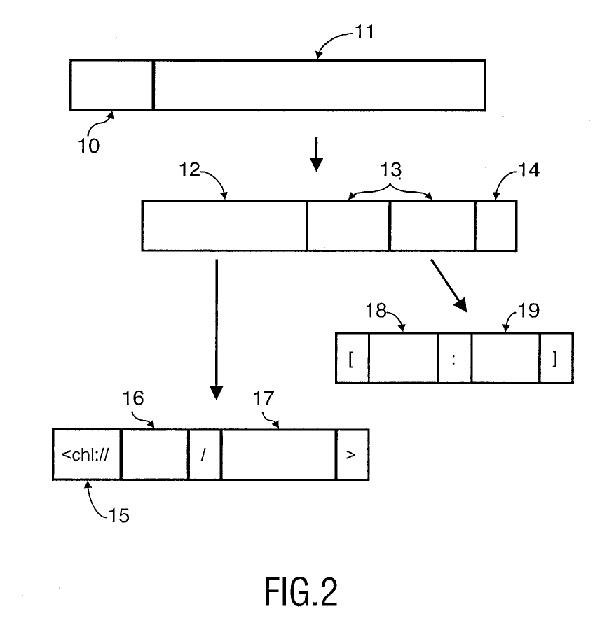

FIG. 2 shows very schematically the composition of a trigger message used in an embodiment of the invention,

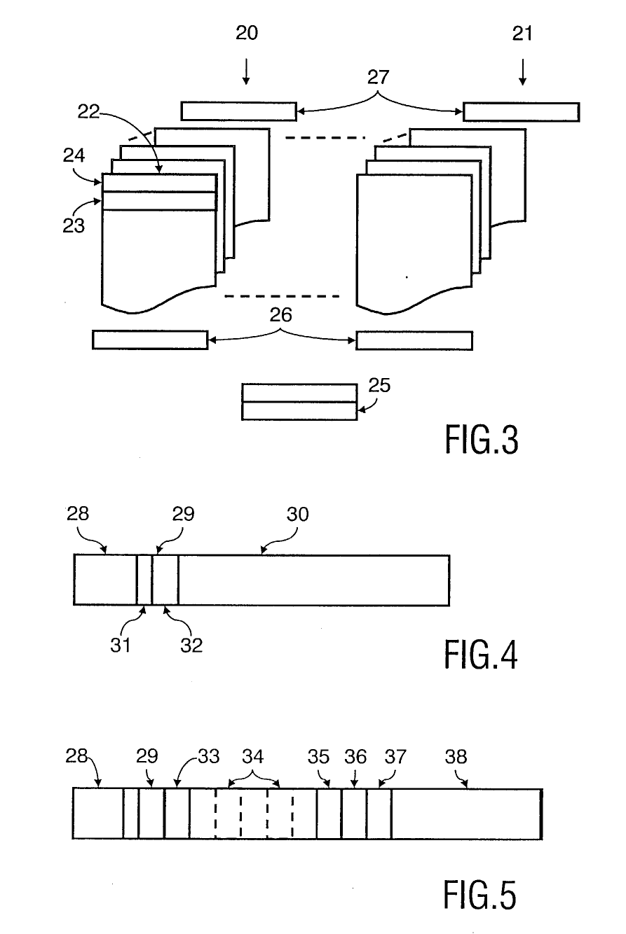

FIG. 3 shows very schematically the composition of a teletext service, as can be used to transmit trigger messages to a television receiver,

FIG. 4 shows the general structure of a teletext packet comprised in the teletext service of FIG. 3,

FIG. 5 shows very schematically the composition of a teletext packet comprising a trigger message.

FIG. 1 shows in a very schematic way the set-up of a television broadcast system according to the invention, demonstrating the many and various situations in which the invention can be used. A television broadcast station 1 generates a television broadcast signal, comprising a number of channels, to be transmitted at different frequencies.

In order to illustrate the various ways in which this signal can be made available to the viewing audience, FIG. 1 shows schematically an aerial 2 for terrestrial broadcasting. The signal broadcast is picked up by an antenna 3 attached to a user's television set 4. As an alternative, the television signal can be broadcast through a cable network 5, in analogue or digital format. In the latter case, it can be sent as a data stream over the Internet, and viewed on a computer 6. Alternatively, the computer 6 can be fitted with a television tuner card, allowing it to receive and tune in to an analogue television signal. FIG. 1 also shows another possible configuration, with a set-top box 7 and a second television set 8. A television receiver is comprised in the set-top box 7 or the television set 8. The invention is not limited to a particular television broadcasting system. It can be used with any of the existing analogue or digital television formats. Any type of broadcast channel, e.g. network, satellite or terrestrial, and any mode of transmission can be used.

The television receiver is used to tune in to one of the channels comprised in the television signal coming from the broadcast station 1. This channel can then be enjoyed on one of the television sets 4, 8 or the computer 6. As is usual, the user can switch channels using controls provided with the television sets 4, 8 or by issuing the relevant command to the computer 6.

According to the invention, it is also possible to remotely trigger a channel switch. This has the advantage that the user can be made aware of a more interesting programme on another channel. It can also be used for advertising, to prompt users to switch to advertising being broadcast on another channel. Since advertisers know that users often switch away from advertising blocks, a broadcaster able to remotely trigger a switch to their channel at the moment a certain advertisement is being broadcast can demand a premium for advertising space on this channel.

Known methods of remotely effecting a switch in channel require much more activity on the part of the viewer. For example, it is known to provide an overview of programs currently being broadcast in a teletext page. A viewer can select the teletext page and then select one of the channels from the overview after which the television receiver automatically switches to the selected channel, making use of so-called links provided with the teletext page data to identify the channel. This mechanism requires the user to take the initiative. The switching procedure is triggered when the user selects the teletext page containing the overview. The invention allows a channel switch to be triggered even if the viewer is not viewing a teletext page, but watching a regular television programme.

To do this, the invention makes use of data provided by a data broadcast station, for instance a teletext service provider 9. A trigger message is included with the data, recognisable as such by a trigger identifier, as will be more fully explained below. The teletext service can, of course, also be provided from the television broadcast station 1.

The invention does not rely on teletext pages as a medium to transmit the trigger message to the television receiver, but this medium will be used as an example in the description of the invention. The exact way in which trigger messages are broadcast within teletext pages, will be described in more detail below.

Alternative ways of transmitting the trigger messages include encapsulation in UDP/IP multicast packets, useful for reaching an audience making use of the computer 6. It is also possible to transmit the trigger messages using an Independent Dataline Method. Combined systems are conceivable, in which, for example, the computer 6 or the set-top box 7 are capable of receiving both IP packets containing data and the television signal through the network 5.

In the embodiment to be described hereinafter, it will be assumed that the trigger messages are sent encoded in teletext pages. The television receiver comprises a teletext decoder, which has been programmed to recognise the trigger message by a trigger identifier. It will be apparent that television receiver and teletext decoder need not be one single device. A configuration wherein the set-top box 7 comprises the television receiver and the television set 8 the teletext decoder would fall within the scope of the invention.

FIG. 2 schematically breaks down the message into its various components to illustrate the syntax used in the preferred embodiment. This embodiment conforms to the standard defined in EACEM Technical Report TR-037-r01. It will be apparent, however, that an alternative implementation conform a different standard could be used within the scope of the invention.

The trigger message of FIG. 2 comprises a trigger_text_length field 10 defining the number of characters comprised in an appended trigger_text field 11. This is useful, because the trigger_text field 11 can be of varying length, depending on the contents, although the medium used to convey the message might impose a maximum length. The trigger_text field 11 comprises a URL string 12 and one or more attribute strings 13. Optionally, a checksum 14 is used to detect errors introduced during transmission.

According to the invention, the URL string 12 used to trigger a channel switch starts with a trigger identifier 15. This trigger identifier 15 is a short string used to distinguish trigger messages for triggering a channel switch from trigger messages used for other purposes. In the example, the sub-string “ch1” distinguishes the trigger message for a channel switch from other trigger messages. In the method according to the invention, receipt of the message and subsequent detection of this sub-string triggers the channel switching procedure.

The URL string 12 further comprises a CNI identifier 16, a country and network identifier uniquely specifying the channel to switch to. In the preferred embodiment of the invention, all the channels to which a switch is possible have their own CNI code. However, occasionally, a channel has no CNI code, in which case the CNI identifier 16 has value 0. The channel to switch to can then be specified in a network name field 17. The decoder receiving the message will be programmed to recognise the specification, so that it is also possible to switch to channels without a CNI identifier 16, for example an information channel provided by a cable network operator. Common to these implementations is that the URL string 12 comprises a resource indicator, a specification of the information resource to which a switch can be made.

In the preferred embodiment of the invention, although the channel switch is triggered by receipt of the trigger message and recognition of the trigger identifier 15, the channel switch is not automatically completed. Instead, the user is prompted to confirm the channel switch.

The prompt is provided by means of a dedicated attribute string 13. The attribute string 13 comprises an attribute name 18 and an attribute value 19. The attribute name 18 is a single character or a short string, identifying the attribute string 13 as an attribute string for providing a user prompt. Within the above-mentioned standard for trigger messages, the string “name” or character “n” is used to distinguish the attribute string 13 for providing a user prompt.

The decoder processing the trigger messages uses the presence of this string 18 or character as a cue for generating an icon that pops up on the screen of the television set 4, 8 or computer 6. It is thus, that a viewer is made aware of the fact that something that might be of interest to him can be watched on another channel. Upon confirmation of the prompt through one of the controls provided with the television set 4, 8 or by means of a command to the computer 6, the television receiver automatically switches to the channel specified in the URL string 12.

The attribute value 19 comprises a string, which provides information about the trigger. This information is displayed with the icon. In this way, the viewer can be informed about the channel he is prompted to switch to, or of the reason for the switch.

Other types of attribute string 13 can also be used to advantage, according to the invention. For example, it is advantageous to include a countdown attribute. This attribute string 13 has “countdown” or “c” as its attribute name 18. The attribute value 19 then specifies a time delay. In this way, triggering of a channel switch can be delayed for a certain time interval after arrival of the trigger message.

A way of conveying trigger messages to television receivers by encoding them in teletext pages will now be described with reference to FIGS. 3 and 4, showing the composition of a teletext service and teletext data packet respectively. The embodiment described conforms to teletext broadcasting standard ETS 300 706, used here by way of example only.

The teletext service comprises a number of magazines 20, 21, up to a maximum of 8. Each magazine 20, 21 in turn comprises a number of pages 22. Each page 22 is encoded in packets 23, including a header packet 24. Further packets, which are not part of the pages 22 are also used. Broadcast service data packets 25 define properties for the whole teletext service. Magazine related data packets 26 define properties for all the pages 22 in a magazine 20, 21. Time filling headers 27 are used to signal the end of the last page 22 in a magazine 20, 21.

Turning to FIG. 4, each data packet 23 comprises a synchronisation sequence 28, a packet address 29 and data 30. The packet address 29 in this example consists of a magazine number 31 and a packet number 32. The packet number 32 indicates the kind of packet concerned. For example, each header packet 24 has packet number 32 of value zero. From this value of the packet number 32, the teletext decoder knows that the data 30 of the packet comprises the page address, which is provided with the header packet 24, but not with all the other packets. Values one to twenty-four are reserved for displayable packets, in which the data 30 consists of data displayable in a teletext page. Packets with a value for the packet number 32 between twenty-five and twenty-eight are designated as extension packets.

In the embodiment of the invention described here, trigger messages are sent in specially designated pages, not intended for display. These pages are inserted in the transmission of normal pages. A page containing trigger messages is preferably identifiable by its address, provided in the header packet 24 for the page. Otherwise, a magazine inventory page, comprised in the magazine with which the page is sent, will indicate the address of the page containing trigger messages.

A page containing trigger messages need not have all of the twenty-four packets that a page with displayable data normally has. The header packet 24 for the page containing trigger messages details the number of packets of which the page consists. It should preferably, however, have a packet with packet number value twenty-eight. This packet contains a code that confirms that the page concerned contains trigger messages.

To send a trigger message in the data packet, each 8-bit byte of the trigger message is divided into two nibbles, which are encoded. The resulting bytes are assembled in sequence to form an Application Data block 37. The Application Data block 37 is inserted into a packet, such as is schematically shown in FIG. 5.

A packet need not exclusively comprise one Application Data Block 37. Also, Application Data Blocks are not all of one size, whereas a teletext packet has a standard size. To ensure that a teletext decoder can correctly identify and extract the trigger message, the packet containing it has a specific composition, as will now be explained with reference to FIG. 5.

Next to the synchronisation sequence 28 and the packet address 29, the packet further comprises a block pointer 33. The block pointer 33 indicates where in the packet the Application Data block 37 is to be found. One or more filler bytes 34 can separate the block pointer 33 from the Application Block 37. Thus, the packet can be padded to the correct standard teletext packet size. A block separator 35 signals that the Application Data Block 37 is about to begin. The Application Data Block 37 is first preceded by a structure header 36, defining the type and length of the Application Data Block 37. The teletext decoder is programmed to recognise the Application Data Block 37 from the structure header 36, so that it can be passed as input to an application for processing trigger messages.

Further Application Data Blocks 38 can be present, which do not necessarily have to be part of the present invention. Application Data Blocks for applications other than the one implementing the trigger mechanism of the present invention can be present.

As an alternative to sending trigger messages in teletext packets, trigger messages can also be sent encapsulated in UDP/IP multicast packets. Such packets can be transmitted using an independent data line method, i.e. sent in unused lines in a television signal. An appropriate teletext decoder can receive the data sent in this way. Otherwise, multicast packets could be sent over the Internet, especially useful when the computer 6 is being used to also receive the television signal.

It will be apparent to those skilled in the art that the invention is not limited to the above-described embodiments, which can be varied in a number of ways within the scope of the attached claims. For instance, the invention is not limited to a specific broadcast format. It can be implemented in PAL/SECAM/NTSC formats, digital television and Internet-based broadcasting or multicasting television formats.

1. Television receiver arrangement, comprising means for receiving a television signal comprising a plurality of channels and a tuner for tuning in to one of the channels, and capable of receiving data broadcast transmissions, the arrangement further comprising a data processor for decoding the data (30), which data processor is adapted to directing the tuner to switch to a channel specified in a resource indicator (16, 17) comprised in the data (30) characterised in that the data processor is programmed to trigger a channel switch upon receipt and identification of a specific trigger identifier (15) comprised in the data (30).

2. Method of effecting a channel switch in a television receiver (4, 6-8) capable of receiving and tuning in to one of a plurality of channels provided in a television signal, wherein
data broadcast transmissions are received and decoded;
a resource indicator (16, 17) specifying a channel is extracted from the data (30) received; and
the television receiver (4, 6-8) is instructed to switch to the specified channel,
characterised in that
the channel switch is triggered by receipt and identification of a specific trigger identifier (15) in a message comprised in the data (30).

3. Method according to claim 2, wherein the trigger message comprises an attribute (13), prompting the user to confirm the channel switch, wherein the channel switch is completed upon the user's confirmation.

4. Method according to claim 3, wherein the attribute (13) further comprises an information string (19), wherein the information contained therein is made available to the user with the prompt.

5. Television broadcast system, comprising
a television broadcast station (1) for transmitting at least one television signal comprising a number of channels;
a data broadcast station (9) for providing and transmitting data (30), comprising at least a resource indicator (16, 17) specifying one of the channels;
at least one television receiver (4, 6-8), for receiving the television signal and data (30) and tuning in to one of the channels; and
at least one broadcasting channel (5) connecting the television receiver(s) (4, 6-8) to the broadcast stations (1, 9), wherein a specific trigger identifier (15) comprised in the data (30) provides a trigger to the television receiver (4, 6-8) to tune in to the specified channel.

6. Television broadcast system according to claim 5, wherein the data (30) is broadcast in teletext pages (22), from which a television receiver (4, 6-8) can retrieve the resource indicator (16, 17) and trigger identifier (15).

7. Television set (4, 8), comprising a television receiver arrangement according to claim 1.

8. Trigger message, suitable for reception by a television receiver (4, 6-8), comprising a URL-string (12) uniquely identifying the trigger message as an instruction to the television receiver (4, 6-8) to tune in to a different channel.

9. Trigger message according to claim 8, wherein the URL-string (12) further comprises a specification (16, 17) of the channel to switch to.

10. Trigger message according to claim 8 or 9, further comprising an attribute (13), comprising a string (19) for display as a prompt on a television (4, 8) connected to or comprising the television receiver (4, 6-8).
